(19) United States
(12) Patent Application Publication
(10) Pub. No.: US 2005/0031832 A1
(43) Pub. Date: Feb. 10, 2005

(54) MULTI-LAYER CONDUCTIVE/INSULATION PAD

(75) Inventors: Charles Kannankeril, North Caldwell, NJ (US); Dale Tokarski, Carmel, IN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US), Saddle Brook, NJ (US)

(21) Appl. No.: 10/637,282

(22) Filed: Aug. 8, 2003

Related U.S. Application Data
(66) Substitute for application No. 10/637,282, filed on Aug. 8, 2003.

(51) Int. Cl. B32B 1/00

(52) U.S. Cl. 428/178

(57) ABSTRACT

Abstract of the Disclosure

There is provides a multi-layer conductive/insulation pad is provided having a first polymer layer, a conductive layer such as a thin foil of metal or a metallized thermoplastic film laminated to the first polymer layer, a second polymer layer laminated to the side of the conductive layer opposite the side of the first polymer layer, and a first bubble wrap layer. The first bubble wrap layer is laminated to the side of the second polymer film opposite the conductive layer. Optionally, a protective heavy-duty polymer layer is laminated to the first bubble wrap layer on the opposite side of the second polymer layer. In another embodiment the multi-layer construction of pad of the first embodiment has added thereto a third polymer layer laminated to the side opposite the first layer of bubble wrap and a second layer of bubble wrap laminated to the third polymer layer on the side opposite the first bubble wrap. Optionally, a protective heavy-duty polymer layer is laminated to the first bubble wrap layer on the opposite side of the second polymer layer.

### Detailed Description of the Invention

### Background of Invention

FIELD OF THE INVENTION.The present invention relates generally to a multi-layer conductive/ insulation material. More particularly, this invention relates to a multi-layer pad having both conductive and insulating properties that is particularly suitable for use under a concrete slab.

DESCRIPTION OF THE PRIOR ART.Materials to control the movement of heat have been used for many years and in many forms depending upon the desired use. For example, a variety of materials such as sawdust, straw, wool blankets and bats of foam or fiberglass have been used for insulation. However, special uses require materials having special insulating characteristics. One of these special uses is to prevent radiant heat transfer under concrete slabs. In many parts of the country houses, driveways and the like are constructed on concrete slabs laid either directly on the ground or on sub-flooring. Many of these types of structures are heated through hot water systems or electrical circuits embedded in the concrete. When such construction is used the radiant heating goes upward into the room and downward through the ground or sub-flooring. It is therefore desirable to prevent or substantially reduce the amount of heat lost to the ground. One such means for reducing heat loss is to install a system of reflective cushioning material with sealed pockets of air.

Numerous suggestions for insulating materials for use under concrete slabs have been made. For example, United States Patent No. 6,188,839 to Pennella discloses a two-layer insulation assembly for use under a concrete slab in a radiant heating system. These assemblies include a rigid honeycomb panel forming a plurality of insulating pockets alternatively disposed on the top and bottom surfaces of the honeycomb and a reflective layer above the honeycomb to reflect heat away from the honeycomb panel.

In United States Patent No. 6,514,596 to Orologio there is described the use of separating sheets to thermally separate construction materials from underground soils to retain the soil in place and to serve as moisture barriers. This patent discloses an insulating material having thermal and moisture resistance. The sheet includes a structure in which a metal foil is bonded between two bubble-wrap layers. The foil is separated from the concrete by an insulation layer of bubble wrap. The insulating material described in this patent is stated to reduce heat transfer.

United States Patent No. 6,248,433 to Annestad discloses a multi-layer thermal material used, for example, to cover ice skating rinks. The multi-layered material includes an outer polyester sheet, an insulation layer and an aluminum film layer positioned between an inner surface of the polyester sheet and an outer surface of the insulation layer. The aluminum film may be coated onto the polyester sheet. The thermal material of Annestad is used to keep cold in and heat out.

In view of the state of the art, there is a desire to provide a conductive/insulation pad suitable for use under a concrete pad that prevents or substantially reduces the radiant energy from spreading out under the concrete slab.

### Summary of Invention

BRIEF SUMMARY OF THE INVENTIONDespite numerous attempts to provide an effective product that can be used to insulate under concrete slabs, the materials presently used in the art are not altogether effective. Although there is ample evidence that bubble pack products work in insulating under concrete slabs, it has been further suggested that the performance is from the foil reflecting radiant energy. It has been found that this theory is incorrect as it is a well-known fact that coating the foil surface or applying a film to it will substantially reduce the reflectivity of the foil. Moreover, it has been found that the use of the conductive/insulation pad of this invention reduces or eliminates ground water intrusion into the concrete slab. Cold ground water will reduce the performance of a radiantly heated slab. Secondly, the aluminum foil does not act as a reflector as well as it does a conductor of heat allowing radiant energy to spread out under the slab improving performance.

In accordance with the present invention, there is provided a multi-layered conductive/insulation pad. In a first embodiment of the invention a multi-layer conductive/insulation pad is provided having, in order, a first polymer layer, a conductive layer, such as a thin foil of metal or a metallized thermoplastic film, laminated to the first polymer layer, a second polymer layer laminated to the side of the conductive layer opposite the side of the first polymer layer. At least one bubble wrap layer is laminated to the side of the second polymer film opposite the conductive layer. Optionally, a protective polymer layer is laminated to the first bubble wrap layer on the opposite side of the second polymer layer. The first and second polymer layers are laminated to the opposite sides of the conductive layer to protect the layer from oxidizing and to protect the layer from the lime in the curing concrete, and, when used directly on the soil, the alkali content in the soil. The insulation component (bubble wrap) prevents the ground water intrusion into the concrete slab, as well as heat loss into the cold ground water. The conductive layer, i.e., foil or metallized film, conducts the heat throughout the layer allowing radiant energy to spread out under the slab.

For the product to be efficient, the conductive layer needs to be as close as possible to the concrete slab, without having any insulation between the slab and the conductive layer. An advantage of the pad of the present invention is that the bubble wrap layer insulation between the conductive layer and the concrete slab is eliminated which makes the conductive layer a more effective conductor of heat allowing radiant energy to spread out under the concrete slab.

In another embodiment of the present invention the multi-layer construction of the pad of the first embodiment has added thereto a second layer of bubble wrap laminated to a third polymer layer on the side opposite the first bubble wrap. Optionally, a protective polymer layer is laminated to the second layer of bubble wrap on the side opposite the third polymer layer.

After the ground or sub-flooring has been prepared for pouring a concrete slab, the conductive/insulation pad of one of the embodiments of the present invention is placed directly on the soil or the sub-flooring. Typically, a heating element is placed on the conductive/insulation pad, generally slightly above the layer, so that some of the concrete may settle under the heating element and so that when the heating element is activated, heat generated from the heating element is conducted away from the pad allowing radiant energy to spread out under the concrete pad. After the concrete slab with the heating element embedded therein, dries a floor surfacing, such as tile or the like may be laid.

It is, therefore, an object of the present invention to provide a conductive/insulation pad having a conductive component consisting of a foil or metallized film protected by polymer films on both sides and an insulation component consisting of at least one layer of bubble wrap.

Another object of the present invention is to provide a reflective layer that conducts heat throughout the layer allowing radiant energy to spread out under the slab and preventing dispersal of heat below the reflective surface.

An additional object of the present invention is to provide a concrete pad having a foil or metallized film that is protected by pigmented polyethylene on one side for surface identification purposes.

Yet another object of the present invention is to provide a concrete pad in which the insulation layer is protected from sharp ground objects by an additional layer of heavy-duty polymer film.

Other objects, features and advantages of the present invention will become apparent from the following detailed description of the invention taken in conjunction with the accompanying drawings.

### Brief Description of Drawings

Having thus described the invention in general terms, reference will now be made to the accompanying drawings, which are not necessarily drawn to scale, and wherein:

FIG. 1 is a perspective view in partial section of the conductive/insulation pad of the present invention as it is used to conduct radiant heating across a concrete floor;

FIG. 2 is a diagramic enlarged sectional view of a first embodiment of the conductive/insulation pad of the present invention taken along line 2-2 of FIG.

FIG. 3 is a diagramic enlarged sectional view of a second embodiment of the conductive/insulation pad of the present invention also taken along line 2-2 of FIG. and

FIG. 4 is another perspective view in partial section of the conductive /insulation pad of the present invention illustrating use in another environment.

### Detailed Description

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

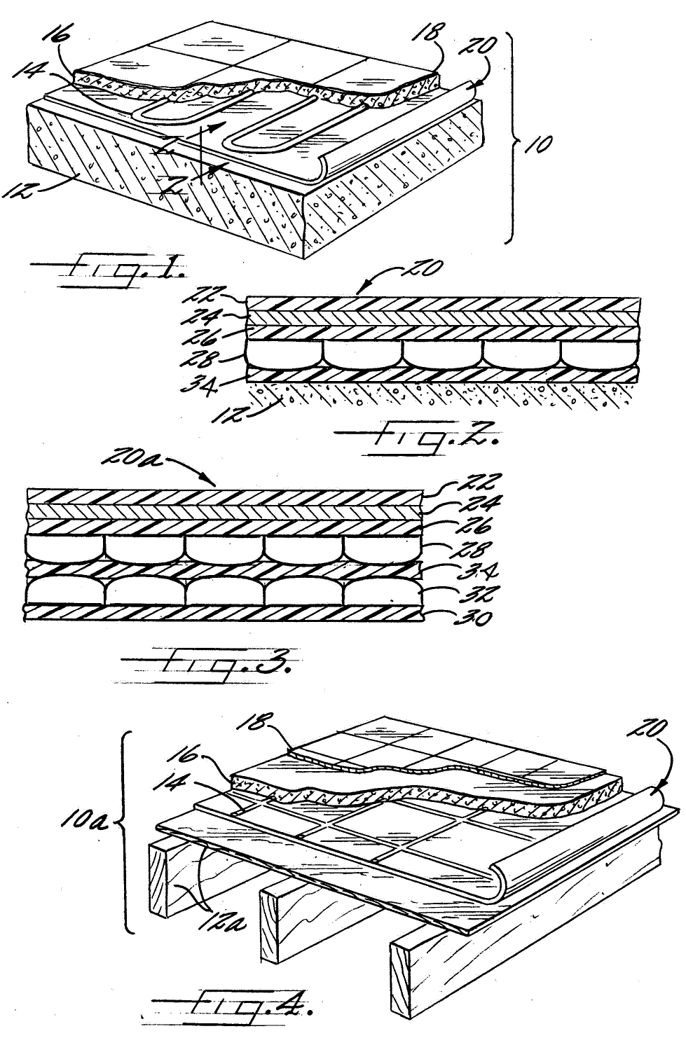

Referring more particularly to the drawings, there is shown in FIG. 1 a perspective view of a radiant heating assembly 10 showing a conductive/insulation pad 20 overlaying the ground 12. A heating element 14 is placed above the conductive /insulation pad 20 and positioned so that the heating element 14 may be surrounded by the concrete slab 16. The concrete slab 16 is poured so that it covers the conductive /insulation pad 20 and embeds the heating element 14. After the concrete slab 16 dries, the slab may be covered with tile 18 or other type of flooring material.

In FIG. 2 there is shown a first embodiment of the multi-layer conductive/insulation pad 20 of the present invention. This embodiment is a four or five layer construction wherein there is a first polymer layer 22. Layer 22 is a clear or pigmented polymer layer. Following the first polymer layer 22 is a conductive layer 24 laminated to the first polymer layer 22. The next layer is a second polymer layer 26 laminated to the side of the conductive layer 24 opposite the side of the first polymer layer 22. The next layer is at least one layer of bubble wrap 28 laminated to the side of the second polymer layer 26 opposite conductive layer 24. An optional protective layer of polymer material 30 is laminated to the bubble wrap layer 28 to the side opposite the second polymer layer 26. The protective layer 30 is a heavy-duty polymer layer to protect the bubble wrap layer from sharp ground objects. The concrete pad 20 conducts radiant the heating provided by heating element 14 upward through the concrete allowing radiant energy to spread out under the concrete pad. The pad is flexible allowing easy installation and may be rolled up so that it can be easily transported.

FIG. 3 illustrates another preferred embodiment of the conductive /insulation pad of the present invention, pad 20a. This embodiment the uses the five-layer construction of the first embodiment and adds a second layer of bubble wrap 32 laminated to the third polymer layer 34 on the side opposite the first layer of bubble wrap 28. An optional protective polymer layer 30 is laminated to the second layer of bubble wrap 32 on the side opposite side of the third polymer layer 34.

The polymer layers may be a polyolefin, such as polyethylene (PE), low density polyethylene (LDPE), polypropylene (PP), co-polymers of polyethylene and polypropylene, polyethylene terephthalates (PET), polyamide, and polyvinyl chloride. A preferred polymer layer is a PETROTHENE^{®} NA345-013, a low density polyethylene film extrusion grade from Equistar Chemicals, LP. These films are preferably extruded at a thickness of about 0.5 mil to about 3.0 mils. The first and second polymer films are coated or attached to both sides of the conductive layer to protect the layer from oxidization and the lime in the curing concrete. The optional protective layer is a heavy-duty layer to protect the bubble wrap from sharp ground objects and alkaline content in the soil. The first polymer layer may be colored or pigmented. The heavy-duty protective layer may also be a durable non-woven polymer film scrim. By coloring the first polymer layer the user may readily be able to determine which side of the pad to have facing upward toward the slab.

The conductive layer is material that will reflect heat. In particular a thin foil metal or metallized thermoplastic film having conductive/reflective properties may be used. Preferably the foil is aluminum, which has a lower emissive value of less than five percent on each surface to essentially eliminate heat transfer by radiation. The polymer layers on either side of the reflective layer reduce the oxidation of the conductive layer helping to retain the reflectivity of the layer. The conductive/reflective layer, i.e., foil or metallized film, conducts the heat allowing radiant energy to spread out under the slab.

The bubble wrap layer or layers provide both thermal conduction and convection insulation and, in combination with the conductive/reflective surface, excellent radiation insulation. The bubble wrap has a first thermoplastic film having a plurality of portions wherein each of said portions defines a cavity and a second thermoplastic layer in sealed engagement with said first layer to provide a plurality of closed cavities. Such bubble wraps are well known in the industry and are readily available from Sealed Air Corp. The insulation component (bubble wrap) prevents the ground water intrusion into the concrete slab as well as heat loss into the cold, water/ground layer.

The conductive/insulation pads 20 and 20a offer significant resistance to heavy loading, whereby appreciative non-breakage of air bubbles is often found. Preferably, outer polymer layers are made slightly thicker than the inner layers to better resist abrasion.

The multi-layer conductive/insulation pads are lightweight and thin. For example, a typical pad weights about 1.20 to 1.50 ounces per square foot. The pads are typically from about 0.2 cm to about 0.8 cm thick, preferably about 0.3 to about 0.35 cm. thick. The thinness and flexibility of the pads facilitates the manufacture, transportation and handling of rolls of different desired sizes.

Referring now to FIG. 4, there is provided an alternative embodiment of a radiant heating assembly 10a showing a conductive/insulation pad 20 installation overlaying the a sub-flooring 12a. The pad 20 is the same pad used in the embodiment of FIG. 1. As in FIG. 1, a heating element 14 is placed above the pad 20 and positioned so that the element 14 is surrounded by the concrete slab 16. The concrete slab 16 is poured so that it covers the pad 20 and embeds the heating element 14. After the concrete slab dries, the slab may be covered with tile 18 or other type of flooring material.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A multi-layer conductive/insulation pad comprising;
(a) a first polymer layer;
(b) a conductive layer laminated to said first polymer layer;
(c) a second polymer layer laminated to the side of said conductive layer opposite the side of said first polymer layer; and
(d) at least one bubble wrap layer being laminated to the side of said second polymer layer opposite said conductive layer.

2. The multi-layer conductive/insulation pad according to Claim 1 further comprising a protective polymer layer being laminated to said bubble wrap layer to the side opposite said second polymer layer.

3. The multi-layer conductive/insulation pad according to Claim 1 further comprising:
(e) a third polymer layer being laminated to a first bubble wrap layer to the side opposite said second polymer layer; and
(f) a second layer of bubble wrap laminated to said third polymer layer on the side opposite said first bubble wrap.

4. The multi-layer conductive/insulation pad according to Claim 3 further comprising a protective polymer layer being laminated to said second bubble wrap layer to the side opposite said third polymer layer.

5. The multi-layer conductive/insulation pad according to Claim 1 wherein said conductive layer is a thin foil of metal or a metallized thermoplastic layer.

6. The multi-layer conductive/insulation pad according to Claim 1 wherein said conductive layer is aluminum.

7. The multi-layer conductive/insulation pad according to Claim 1 wherein said polyolefin film is selected from the group consisting of a polyethylene, low density polyethylene, linear low density polyethylene, co-polymers of polyethylene and polypropylene, polyethylene terephthalate, polyamide, and polyvinyl chloride.

8. The multi-layer conductive/insulation pad according to Claim 4 wherein said polyolefin film is selected from the group consisting of a polyethylene, low density polyethylene, linear low density polyethylene, co-polymers of polyethylene and polypropylene, polyethylene terephthalate, polyamide, and polyvinyl chloride.

9. The multi-layer conductive/insulation pad according to Claim 1 wherein said first polymer layer is a pigmented polymer film.

10. A method of installing a radiant density floor heating system comprising:
(a) disposing a multi-layer conductive/insulation pad comprising;
a first polymer layer; a conductive layer laminated to said first polymer layer; a second polymer layer laminated to the side of said conductive layer opposite the side of said first polymer layer; at least one bubble wrap layer being laminated to the side of said second polymer layer opposite said conductive layer;
(b) positioning a heating element on said pad so that when said heating element is activated, heat generated from said heating element is reflected away from said pad;
(c) providing a layer of cement on said pad and said heating element; and
(d) placing a flooring material on said layer of cement so that said flooring material is embedded within said layer of cement.

11. The method of Claim 10 wherein said pad further comprises and a protective polymer layer being laminated to said bubble wrap layer to the side opposite said second polymer layer.

12. The method of Claim 10 wherein said pad further comprises a third polymer layer being laminated to said bubble wrap layer on the side opposite said polymer layer, and second layer of bubble wrap laminated to a third polymer layer on the side opposite said first bubble wrap.

13. The method of Claim 12 wherein said pad further comprises and a fourth polymer layer laminated to said second layer of bubble wrap on the side opposite said second bubble wrap layer.
